(19) United States
(12) Patent Application Publication
(10) Pub. No.: US 2023/0182520 A1
(43) Pub. Date: Jun. 15, 2023

(54) WHEEL MODULE FOR A MOTOR VEHICLE

(71) Applicant: Schaeffler Technologies AG & Co. KG, Herzogenaurach (DE)

(72) Inventors: Manfred Kraus, Tuchenbach (DE); Benjamin Wuebbolt-Gorbatenko, Erlangen (DE); Mihaly Kovacs, Sf. Gheorghe (RO); Adrian Husu, Brasov (RO); Marius-Constantin Costache, Malaestii de Jos (RO); Mihai Achim, Brasov (RO)

(21) Appl. No.: 17/923,654

(22) PCT Filed: Mar. 30, 2021
(86) PCT No.: PCT/DE2021/100311

§ 371 Date: Nov. 7, 2022

(30) Foreign Application Priority Data
May 8, 2020 (DE) 10 2020 112 535.6

(51) Int. Cl. B60G 3/14

(52) U.S. Cl. CPC B60G 3/14; B60G 2200/132; B60G 2200/44; B60G 2202/42

(57) ABSTRACT

A wheel module (14) for a motor vehicle has a wheel rotatable about a center of rotation and serves for the propulsion of the motor vehicle, and having a swing arm attachable to a supporting frame of the motor vehicle so as to be articulated about a pivot axis and by which forces which act on the wheel are supported on the supporting frame. The center of rotation of the wheel and the pivot axis of the swing arm lie on an imaginary radial line beginning at the center of rotation of the wheel. The radial line runs at an angle α of −40°≤α≤35° with respect to an X-Y plane of the motor vehicle.

### CROSS-REFERENCE TO RELATED APPLICATIONS

This application is the U.S. National Phase of PCT Appin. No. PCT/DE2021/100311 filed Mar. 30, 2021, which claims priority to DE 10 2020 112 535.6, filed May 8, 2020, the entire disclosures of which are incorporated by reference herein.

### TECHNICAL FIELD

The present disclosure relates to a wheel module for a motor vehicle, with the aid of which the motor vehicle can be steered and/or driven and/or braked and/or damped with the aid of a spring/damper unit.

### BACKGROUND

A motor vehicle with a wheel module is known from CN206679065 U, in which a wheel of the wheel module can be rotated by 90° about a vertical steering axis for parking the motor vehicle, even in narrow parking spaces.

### SUMMARY

There is a constant need to be able to support forces occurring in a wheel module in a space-saving manner.

It is an object of the present disclosure to identify measures that enable a space-saving wheel module.

One embodiment relates to a wheel module for a motor vehicle, in particular multi-track passenger motor vehicle, is provided, having a wheel which is rotatable about a center of rotation and which serves for the propulsion of the motor vehicle, and having a swing arm, which is attachable to a supporting frame of the motor vehicle so as to be articulated about a pivot axis and by means of which forces which act on the wheel are supported on the supporting frame, wherein the center of rotation of the wheel and the pivot axis of the swing arm lie on an imaginary radial line beginning at the center of rotation of the wheel, wherein the radial line runs at an angle α of −40°≤α≤35° with respect to an X-Y plane of the motor vehicle.

A mechanical support of the wheel via the swing arm is not provided in the Z direction above the wheel, but as far down as possible. If the swing arm is to be articulated on the supporting frame as close as possible to the circumference of the wheel, the pivot axis of the swing arm can be articulated in a common height range with the center of rotation of the wheel, in particular in the X direction, at the edge of a wheel housing and/or preferably in the vicinity of a sill of the supporting frame. Forces acting on the contact point of the wheel, in particular transverse forces occurring when cornering, act with a significantly lower lever arm than when the swing arm is articulated above the wheel, so that a bending moment about a bending axis running essentially in the X direction can be reduced. If the swing arm were articulated above the wheel in the Z direction, the effective lever arm for the joint forces to be supported would correspond to at least twice the radius of the wheel, while at the chosen angle α the effective lever arm can be smaller than twice the radius of the wheel. With a negative value of the angle α, when the swing arm is articulated below an X-Y plane including the center of rotation of the wheel, the effective lever arm for the joint forces to be supported in the Y direction can in any case be smaller than the simple radius of the wheel. The bending moments occurring in the articulation of the swing arm when cornering and the transverse forces to be supported can be significantly reduced, so that the swing arm can be designed for a lower load. The use of materials and thus the production costs and the space requirement for the swing arm can be reduced as a result. In addition, load-bearing components of the motor vehicle that are provided anyway and limit entry into the vehicle interior can also be functionalized for the articulation of the swing arm, as a result of which the number of components and the space requirement can be further reduced. By means of the angle α, the swing arm can, with less use of material and a smaller structural space requirement, be articulated particularly close to the underlying surface, with a lever arm which is expedient for the support of transverse forces acting on the wheel, such that a structural-space-saving wheel module is made possible.

An X direction is understood to mean a coordinate direction along a longitudinal axis of a motor vehicle when the wheel module is installed in the motor vehicle. The X direction runs essentially horizontally when the motor vehicle is parked on a flat, horizontally running underlying surface. A Y direction is understood to mean a coordinate direction along a transverse axis of a motor vehicle when the wheel module is installed in the motor vehicle. The Y direction runs essentially horizontally when the motor vehicle is parked on a flat, horizontally running underlying surface. A Z direction is understood to mean a coordinate direction along a vertical axis of a motor vehicle when the wheel module is installed in the motor vehicle. The Z direction runs essentially vertically when the motor vehicle is parked on a flat, horizontally running underlying surface. The X direction, Y direction and Z direction are orthogonally aligned with one another. The X direction and the Y direction can span an X-Y plane, which is arranged at a specific height in the Z direction in a horizontal plane of the motor vehicle when the motor vehicle is parked on a flat, horizontally running underlying surface. The X direction and the Z direction can span an essentially vertical X-Z plane, which at a specific position in the Y direction represents a longitudinal section of the motor vehicle running in the longitudinal direction of the motor vehicle when the motor vehicle is parked on a flat horizontally running underlying surface. The Y direction and the Z direction can span a Y-Z plane lying essentially in a vertical direction, which represents a cross-section of the motor vehicle running in the transverse direction of the motor vehicle at a specific position in the X direction when the motor vehicle is parked on a flat, horizontally running underlying surface.

In particular, the angle α is −30°≤α≤20°, in particular −20°≤α≤0°. As a result, the swing arm can be articulated particularly closely in the area of a sill of the supporting frame. The joint forces occurring at the linkage point of the swing arm can thus be transferred to the supporting frame, in particular to the sill, via a correspondingly short lever arm.

Preferably, the pivot axis has a distance d from an underlying surface of 60 mm≤d≤650 mm, in particular 80 mm≤d≤590 mm, preferably 100 mm≤d≤260 mm. With such a distance from a road surface, the transverse forces acting on the swing arm can be supported on the supporting frame with a small lever arm. In addition, the distance from the ground is large enough so that the swing arm does not touch the ground if there are any bumps in the ground to be taken into account; for example, a pothole in the road.

Particularly preferably, a shock absorber which acts on the swing arm and can be supported on the supporting frame of the motor vehicle is provided for damping vibrations of the wheel caused by unevenness in the roadway, wherein the wheel can be supported exclusively via the swing arm and the shock absorber on the supporting frame of the motor vehicle for the purpose of dissipating forces. The shock absorber can impress a sufficient contact force for the wheel and dampen vibrations of the wheel caused by bumps in the road. These vibrations of the wheel can be followed by the swing arm due to the articulated support of the swing arm. The force direction of the shock absorber is preferably aligned predominantly in the Z direction. As a result, the shock absorber can predominantly support the forces occurring in the Z direction, while the swing arm can predominantly support the forces occurring in the X direction. An angle between the force direction of the shock absorber and the radial line running from the center of rotation of the wheel to the axis of rotation of the swing arm of greater than 45°, in particular greater than 60°, preferably greater than 80°, can reduce the forces that occur in the shock absorber and the swing arm with low lateral loads at a low use of materials and small space requirements are well supported. Further supporting components are therefore not required and can be saved, as a result of which the space requirement and the production costs can be kept low.

In particular, a wheel carrier rotatably mounted on the swing arm and attached to the wheel for steering the wheel and an electrically operable steering actuator attached to the swing arm and acting on the wheel carrier for rotating the wheel carrier are provided. The steering actuator is attached to the swing arm and can use the swing arm to support the forces twisting the wheel carrier. An attachment of the steering actuator to the supporting frame is not provided and is provided only indirectly via the swing arm. Electrical lines provided for controlling the steering actuator can follow a relative movement of the steering actuator relative to the supporting frame as a result of a pivoting movement of the swing arm and can have a suitable length and a suitable cable routing for this purpose. The steering actuator can have a rotor coupled to a shaft, in particular arranged axially offset, so that an electromagnetic rotation of the rotor leads to a rotation of the wheel carrier attached to the shaft and the wheel connected to the wheel carrier. By axially offsetting the steering actuator from the axis of rotation of the wheel carrier, the steering actuator can be provided in an area within a wheel housing, which means that no installation space has to be reserved for the steering actuator outside of the wheel housing.

Preferably, the swing arm has a lower bearing and an upper bearing provided essentially in the Z direction above the lower bearing for turning the wheel about a Z axis running through the lower bearing and the upper bearing, wherein the lower bearing and the upper bearing are connected to one another via a swing arm body formed by the swing arm, in particular extending in a curved manner, to enable a steering lock of the wheel by at least 90°, wherein at least one steering lever projects from the swing arm body for articulated connection to the supporting frame of the motor vehicle. The curved swing arm body, which can correspond to the contours of a wheel housing, for example, frees up installation space for the wheel, into which the wheel can rotate even at extremely large angles of rotation of over 90°. Compared to a straight rod-shaped swing arm running in the Z direction, the wheel cannot hit the steering lever of the swing arm, so that the steering angle of the wheel is not blocked and limited by the steering lever. Due to the large steering angle that is made possible, it is possible for the motor vehicle to drive transversely to the direction of travel and/or to turn on the spot. The maneuverability of the motor vehicle can be very high as a result.

Particularly preferably, to enable a steering lock of the wheel by at least 90° with one another, the swing arm extends in an arcuate manner both in an X-Y plane and in an arcuate manner in a Y-Z plane. This reliably prevents the wheel from hitting the swing arm when the steering angle is very large.

In particular, the swing arm is rigid, in particular formed in one piece. The one-sided articulation of the swing arm makes it possible to avoid an articulated two-part design of the swing arm by supporting a shock absorber acting on the wheel not on the swing arm but on the rest of the motor vehicle, in particular directly or indirectly on the supporting frame. This improves the rigidity of the force support via the swing arm and keeps the number of components to a minimum.

One embodiment relates to a motor vehicle with a supporting frame and wheel modules supported on the supporting frame, which can be designed and developed as described above, for steering the motor vehicle, wherein each wheel module enables a steering angle of the wheel of at least 90°. Due to the large steering angle that is made possible, it is possible for the motor vehicle to drive transversely to the direction of travel and/or to turn on the spot. By means of the angle α, the swing arm of the wheel module can, with less use of material and a smaller structural space requirement, be articulated particularly close to the underlying surface, with a lever arm which is expedient for the support of transverse forces acting on the wheel, such that a structural-space-saving motor vehicle is made possible.

Preferably, the supporting frame has a sill formed between a front wheel module in the X direction and a rear wheel module in the X direction, wherein the swing arm is articulated to the supporting frame at the level of the sill, in particular directly to the sill. This makes it possible to support forces occurring on the wheel in the X direction via the swing arm with low component loads. The swing arm provided anyway can easily support the forces and moments introduced by the swing arm.

### BRIEF SUMMARY OF THE DRAWINGS

In the following, the present disclosure is explained by way of example with reference to the attached drawings using preferred exemplary embodiments, wherein it is possible for the features presented below to represent an aspect of the present disclosure both individually and in combination. In the figures:

FIG. 1: shows a schematic side view of part of an electrically driven motor vehicle,

FIG. 2: shows a schematic plan view of a wheel module of the motor vehicle from FIG. 1 with different steering angles,

FIG. 3: shows a schematic front view of the wheel module from FIG. 2,

FIG. 4: shows a simplified detailed view of a first embodiment of the motor vehicle from FIG. 1 and

FIG. 5: shows a simplified detailed view of a second embodiment of the motor vehicle from FIG. 1.

### DETAILED DESCRIPTION

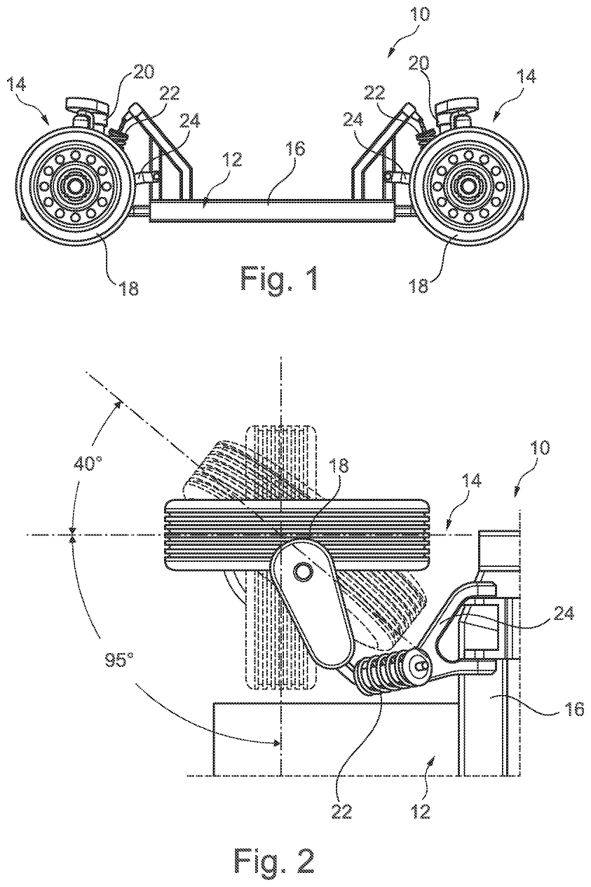

The motor vehicle 10 (only partially shown in FIG. 1) can be provided, for example, as an emission-free electric vehicle for mobility within a city. The motor vehicle 10 has a supporting frame 12 that is in particular essentially rectangular. For example, a wheel module 14 supported directly or indirectly on the supporting frame is attached to each of the corners of the supporting frame. Between a wheel module 14 at the front and a wheel module 14 at the rear in the direction of travel, the supporting frame 12 has a sill 16 designed as a side member, which can delimit and/or support a lower edge of an entrance into a motor vehicle interior. The wheel module 14 has a rotatable wheel 18 that can be steered with the aid of a steering actuator 20. Road bumps can be dampened by a shock absorber 22 acting on the wheel 18, wherein the shock absorber 22 is supported at least indirectly on the supporting frame 12 above the wheel 18 in order to support forces occurring on the wheel 18 in the Z direction. The wheel 18 is supported in an articulated manner on the supporting frame 12 via a swing arm 24 in order to support forces occurring on the wheel 18 in the X direction and in the Y direction. Due to the articulated connection of the swing arm 24, an up and down movement of the wheel 18 made possible by the shock absorber 22 can be followed.

As shown in FIG. 2, the wheel 18 can be turned through more than 90°. As a result, the motor vehicle 10 can also drive transversely to the direction of travel and/or turn on the spot. For this purpose, in particular each wheel 18 of the respective wheel module can be controlled and driven individually, so that a specific steering angle and a specific direction of rotation can be specified individually for each wheel 18 in order to realize a correspondingly large number of motor vehicles. In the exemplary embodiment shown, the wheel 18 can be deflected, starting from a position for straight-ahead travel, in one direction of rotation by at least 90°, in particular approximately 95°, and in the other direction of rotation by approximately 40°. For this purpose, the swing arm 24 is sufficiently curved in the X-Y plane so that the wheel 18 cannot hit the swing arm 24.

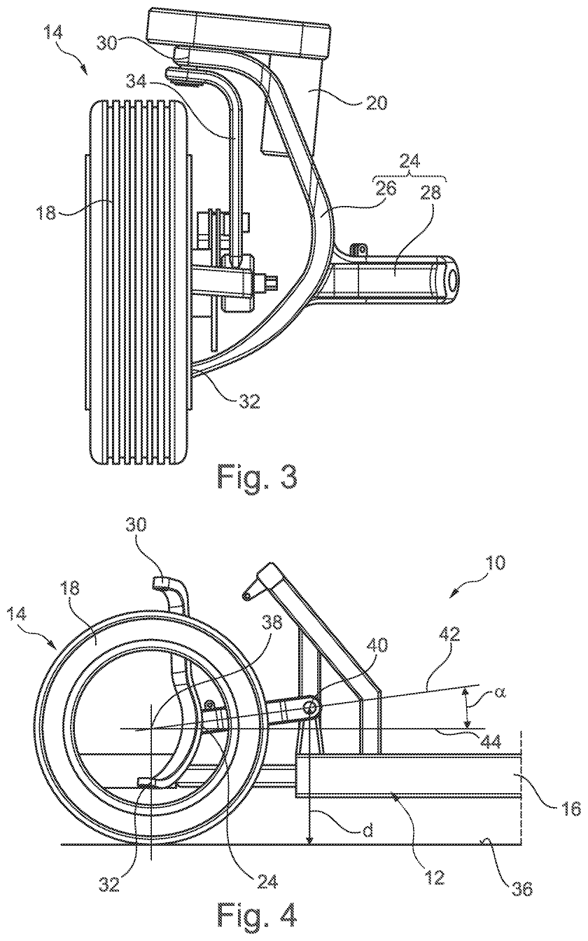

As shown in FIG. 3, the swing arm 24 can have a swing arm body 26 that is also bent in the Y-Z plane, from which at least one steering lever 28 articulated on the supporting frame 12 projects. The swing arm body 26 has an upper bearing 30 and a lower bearing 32, with the aid of which a wheel carrier 34 is rotatably mounted about an axis of rotation running essentially in the Z direction. The wheel carrier 34 is connected to the wheel 18 and can be rotated by the steering actuator 20. The steering actuator 20 is offset from the axis of rotation of the wheel carrier 34 and is coupled essentially axially parallel to a shaft rotating the wheel carrier; for example, via a gear wheel pairing and/or a traction drive. The steering actuator 20 protrudes radially inwards, which saves installation space and the steering actuator 20 can be easily attached to the swing arm 24 outside a steering area of the wheel 18, for example to prevent the steering actuator 20 from turning with the wheel carrier 34.

In the exemplary embodiment illustrated in FIG. 4, with a tire size of the wheel 18 of 125/70 R15, the swing arm 24 is articulated on supporting frame 12 at a distance d from a substrate 36 of d=590 mm. An imaginary radial line 42 running from a center of rotation 38 of the wheel 18 through a pivot axis 40 at the point of articulation of swing arm 24 on the supporting frame 12 is inclined to an X-Y plane 44 by a mathematically positive angle α of α=35° and articulated close to the sill 16. The distance d from the underlying surface 36 is so small that transverse forces acting on the wheel 18 in the Y direction when cornering only have to be supported by the swing arm 24 on the supporting frame 12 with a small bending moment.

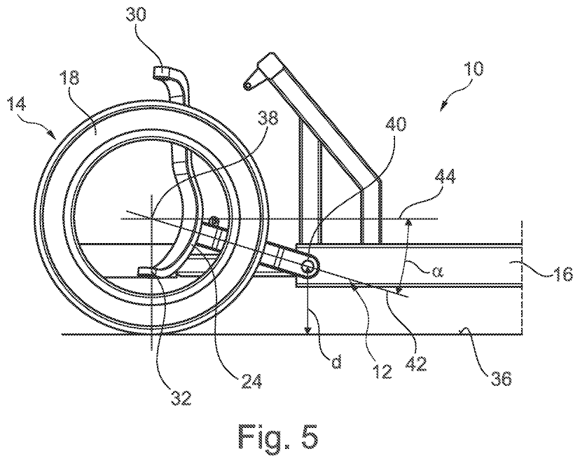

In the exemplary embodiment of the motor vehicle 10 illustrated in FIG. 5, the swing arm 24 is directly articulated to the sill 16 of the supporting frame 12 with a distance d=80 mm and a mathematically negative angle α of the radial line α=−40° compared to the exemplary embodiment of the motor vehicle 10 shown in FIG. 4, whereby the bending moments to be supported by the swing arm 24 to the supporting frame 12 can be reduced even further with sufficient ground clearance. It is also possible to articulate the swing arm at different values for the angle α; for example, at an angle of α=0°.

### LIST OF REFERENCE SYMBOLS

10 Motor vehicle
12 Supporting frame
14 Wheel module
16 Sill
18 Wheel
20 Steering actuator
22 Shock absorber
24 Swing arm
26 Swing arm body
28 Steering lever
30 Upper bearing
32 Lower bearing
34 Wheel carrier
36 Underlying surface
38 Center of rotation
40 Pivot axis
42 Radial line
44 X-Y plane
d Distance
α Angle

What is claimed is:

1. A wheel module for a motor vehicle comprising:
a wheel which is rotatable about a center of rotation and which serves for propelling the motor vehicles; and
a swing arm configured for being attachable to a supporting frame of the motor vehicle so as to be articulable about a pivot axis and by which forces which act on the wheel are supported on the supporting frame,
wherein the center of rotation of the wheel and the pivot axis of the swing arm lie on an imaginary radial line beginning at the center of rotation of the wheel, wherein the imaginary radial line runs at an angle α of −40°≤α≤35° with respect to an X-Y plane of the motor vehicle.

2. The wheel module according to claim 1, wherein the angle α is −30°≤α≤20°.

3. The wheel module according to claim 1, wherein the pivot axis has a distance d from an underlying surface of 60 mm≤d≤650 mm.

4. The wheel module according to claim 1, wherein a shock absorber which acts on the swing arm and can be supported on the supporting frame of the motor vehicle is provided for damping vibrations of the wheel caused by unevenness in a roadway, wherein the wheel is supportable exclusively via the swing arm and the shock absorber on the supporting frame of the motor vehicle for dissipating forces.

5. The wheel module according to claim 1, wherein a wheel carrier rotatably mounted on the swing arm and attached to the wheel for steering the wheel and an electrically operable steering actuator attached to the swing arm and acting on the wheel carrier for rotating the wheel carrier are provided.

6. The wheel module according to claim 1, wherein the swing arm has a lower bearing and an upper bearing provided substantially in a Z direction above the lower bearing for turning the wheel about a Z axis running through the lower bearing and the upper bearing, wherein the lower bearing and the upper bearing are connected to one another via a swing arm body formed by the swing arm to enable a steering angle of the wheel by at least 90°, wherein at least one steering lever projects from the swing arm body for articulated connection to the supporting frame of the motor vehicle.

7. The wheel module according to claim 1, wherein the swing arm extends in an arcuate manner both in an X-Y plane and in a Y-Z plane to enable a steering angle of the wheel by at least 90°.

8. The wheel module according to claim 1, wherein the swing arm is rigid.

9. A motor vehicle comprising:
a supporting frame; and
at least one of the wheel module according to claim 1 supported on the supporting frame for steering the motor vehicle, wherein each wheel module enables a steering angle of the wheel of at least 90°.

10. The motor vehicle according to claim 9, wherein the supporting frame has a sill formed between a front wheel module in an X direction and a rear wheel module in the X direction, wherein the swing arm is articulated on the supporting frame at a level of the sill.

11. The wheel module according to claim 2, wherein the angle α is −20°≤α≤0°.

12. The wheel module according to claim 3, wherein the distance d from the underlying surface is 80 mm≤d≤590 mm.

13. The wheel module according to claim 12, wherein the distance d from the underlying surface is 100 mm≤d≤260 mm.

14. A wheel module for a motor vehicle comprising:
a wheel rotatable about a center of rotation for propelling the motor vehicle;
a steering actuator configured or steering the wheel;
a wheel carrier connected to the wheel and rotatable by the steering actuator; and
a swing arm configured for being attachable to a supporting frame of the motor vehicle so as to be articulable about a pivot axis and by which forces which act on the wheel are supported on the supporting frame,
the steering actuator protruding radially inwards with respect to the center of rotation of the wheel such that the steering actuator is attached to the swing arm outside a steering area of the wheel to prevent the steering actuator from turning with the wheel carrier.

15. The wheel module according to claim 14, wherein the center of rotation of the wheel and the pivot axis of the swing arm lie on an imaginary radial line beginning at the center of rotation of the wheel, wherein the imaginary radial line runs at an angle α of −40°≤α≤35° with respect to an X-Y plane of the motor vehicle.

16. The wheel module according to claim 14, wherein the steering actuator is offset from an axis of rotation of the wheel carrier.

17. The wheel module according to claim 14, wherein the swing arm includes an upper bearing and a lowering bearing, the upper bearing being sandwiched between an attachment piece of the steering actuator and an end of the wheel carrier.

18. The wheel module according to claim 14, wherein the swing arm includes a swing arm body having a curved shape and a steering level extending from the swing arm to the pivot axis.

19. A method of assembling a motor vehicle comprising:
providing the wheel module as recited in claim 1; and
connecting the wheel module to a supporting frame at the pivot axis to enable a steering angle of the wheel of at least 90°.
